(19) United States
(12) Patent Application Publication
(10) Pub. No.: US 2022/0236439 A1
(43) Pub. Date: Jul. 28, 2022

(54) Rock physics model for shale volume estimation in subsurface reservoirs

(71) Applicants: Manzar Fawad, Oslo (NO); MD Nazmul Haque Mondol, Oslo (NO)

(72) Inventors: Manzar Fawad, Oslo (NO); MD Nazmul Haque Mondol, Oslo (NO)

(21) Appl. No.: 17/576,956

(22) Filed: Jan. 16, 2022

Related U.S. Application Data
(60) Provisional application No. 63/140,896, filed on Jan. 24, 2021.

(30) Foreign Application Priority Data
Jan. 23, 2021 (NO) 20210088

(51) Int. Cl. G01V 1/50

(52) U.S. Cl. CPC G01V 1/50; G01V 2210/6226; G01V 2210/6222

(57) ABSTRACT

A method for shale volume (Vsh) estimation in subsurface rock formations using the prestack inverted Seismic by calculating the Vsh in a reservoir given the magnitude obtained from the P- to S-wave velocity ratio (Vp/Vs), and acoustic impedance (AI) extracted from the seismic data inversion, comprising the following steps: a) obtaining wireline log data within a zone of interest in a nearby well and determining the suitable cementation and mineralogy factors by calibrating the background water-bearing sand trend containing zero percent shale volume with the reference zero percent shale volume curve onto the acoustic impedance-Vp/Vs ratio plane, b) calibrating Vsh computed from the acoustic impedance-Vp/Vs ratio curves with Vsh obtained from a conventional method by iterating the P-wave velocity (Vpₛₕ) and density (ρₛₕ) of shale, c) obtaining inverted seismic data in the form of Acoustic Impedance (AI) and Vp/Vs ratio cubes, and d) calculating the shale volume using the calibrated rock physics model inputting the obtained parameters from model calibration (cementation factor, mineralogy factor, density and P-wave velocity of shale) along with inverted Vp/Vs ratio and acoustic impedance cubes data, resulting in a Vsh cube.

### THE OBJECT OF THE INVENTION

The present invention is a rock physics model that relates generally to the field of exploration geophysics, and more particularly to identification and characterization of potential hydrocarbon (oil, gas, and natural gas liquids) or CO₂ storage reservoirs in onshore and offshore sedimentary basins, using prestack inverted seismic (Acoustic impedance and Vp/Vs ratio) data acquired onshore or offshore. The invention also relates to subsurface formation interval P-wave velocity (Vp), S-wave velocity (Vs), and bulk density (RHOB) measured from borehole logs in a well as means to calibrate with the output obtained from the inverted data from seismic.

### BACKGROUND FOR THE INVENTION

The prestack inversion of seismic data has in recent years become a valuable tool in investigating potential hydrocarbon-bearing formations. Seismic surveys in general, when used in combination with other available geophysical, borehole, and geological data, provide useful information about the structure and distribution of subsurface rock properties and their interstitial fluids. Oil companies employ interpretation of such seismic data for selecting the sites to drill oil and gas exploratory and development wells. The seismic surveys while providing maps of geological structures also yield useful information for rock typing, fluid identification and quantification.

When borehole logs are available from nearby wells, seismic survey and the subsequent inverted data can be enhanced and calibrated by combining it with the log data.

Extracting reservoir properties from seismic has always been an objective of geophysicists since commercial seismic has been used for hydrocarbon exploration. Standard reservoir characterization workflows comprise seismic inversion and amplitude-variation-with-offset (AVO) or amplitude-variation-with-angle (AVA) analysis. The change in amplitude with angle has long been demonstrated by Zoeppritz in 1919 (Zoeppritz, 1919). Since the Zoeppritz equations were not intuitive, many approximations to solve AVO/AVA have been presented over the years (e.g., Aki and Richards, 1980; Fatti et al., 1994; Goodway et al., 1997; Shuey, 1985; Smith and Gidlow, 1987; Verm and Hilterman, 1995).

Since AI is a function of zero-offset reflection, an elastic impedance (EI) can be computed for non-normal incident angles (Connolly, 1999). The EI contains fluid information. The EI method is further improved by Whitcombe et al. (2002), calling it Extended Elastic Impedance (EEI) with the option of a theoretical rotation angle (chi) from −90° to +90° in the intercept-gradient crossplot space. Particular rotation angles are related to elastic parameters, such as Lambda-Mu-Rho (LMR) (Goodway et al., 1997), and the compressional (P) to shear (S) wave velocity ratio (Vp/Vs). The LMR parameters are useful lithology and fluid discriminators.

Yenwogfai et al. (2017) disclose a method for the determination of shale volume (Vsh) and teaches an integrated approach used to estimate effective porosity (PHIE), shale volume (Vsh), and sand probability from prestack angle gathers and petrophysical well logs comprising combining model-based prestack inversion outputs from a simultaneous inversion and an extended elastic impedance (EEI) inversion into a multilinear attribute regression analysis to estimate absolute Vsh and PHIE seismic attributes. Moreover, Porosity-Impedance relationships and linear regression coefficients link EEI to porosity and shale volume.

Bredesen et al. (2021) disclose a measurement-based data processing method for the determination of shale volume, porosity, P-velocity (Vp), S-velocity (Vs), density (ρ), acoustic impedance (AI) and Vp/Vs-ratios. The study comprises a combination of both prestack and post-stack seismic inversion data in 2D and 3D. Elastic moduli and densities for the mineral and fluid constituents are used in the rock physics modelling, whereby calibrating the facies-dependent rock physics model, the seismic response of varying a particular reservoir parameter, e.g. the porosity, the mineral composition, cementation, and compaction can be studied in a quantitative manner, for example total shale as a function of AI and Vp/Vs for varying porosity.

Recently, Lehocki et al. (2019) suggested an inversion of the Zoeppritz equation (Zoeppritz, 1919) to obtain the ratio of the density of two layers at the layers' interface. The distinction seemed possible employing the density ratio technique even in (initially) cemented rocks as the diagenetic cement dampens the fluid effect on elastic properties. This technique is in a developing stage and needs testing in other lithology-fluid environments.

Regarding the patents, a U.S. Pat. No. 5,583,825A Published on Dec. 10, 1996 related to a method for deriving reservoir lithology and fluid content for a target location from prestack seismic reflection data. The results of the inversion process are a set of subsurface elastic parameters for both the target and calibration locations. Relative magnitudes of these parameters are compared, together with the known subsurface lithology and fluid content at the calibration location, to extract the subsurface lithology and fluid content at the target location.

WO2015191971A1 published on Dec. 17, 2015 disclosed a method for determining shale volume comprising formulating a model based on measurement data from several instruments, wherein seismic attributes may include acoustic impedance, density, Vp/Vs, S-impedance or other anisotropic parameters of areas in a subsurface of the earth, and the seismic inversion encompasses many different seismic data processes, which may be done pre-stack. The rock model may be calibrated and be run iteratively for a survey area and discriminate main rock families and to suggest realistic starting values for both porosity and water saturation and the volume of shale. Other parameters or attributes used in the model include porosity, mineralogy and cementation. The forward modeling in this procedure was based on the existing rock physics and cross property models.

US2008015782A1 published on Jan. 17, 2008 demonstrated an inversion using rock physics model to solve for the lithologic properties and porosity using an iterative process and converging to a solution by optimizing the L1 norm of the difference between bulk elastic properties obtained from the seismic data and values obtained for the same properties by forward modeling with the rock physics model. This was an iterative process converging to a solution by finding a maximum a posteriori estimate (MAP) of the lithologic properties and porosity using model and data covariance matrices estimated from well data and inversion results at the well.

U.S. Pat. No. 7,373,251B2 published on May 13, 2008 utilized acoustic impedance (AI) values from seismic data to predict a designated rock or fluid property in a subsurface geologic volume. In the procedure, a first predicted value of the designated rock or fluid property is compared to the seismic value of acoustic impedance to determine a difference between the predicted and seismic values of AI. The difference is gradually reduced by making a subsequent prediction.

All these methods, however, were mostly qualitative, or used indirect ways to solve for the shale volume. There had been a need to directly relate acoustic impedance with the Vp/Vs ratio with a flexibility to calibrate locally, in consideration of the rock matrix, fluid properties and the in-situ conditions using bore-hole data.

### BRIEF SUMMARY

Therefore, the present invention's main objective is to provide a better and innovative method for the estimation of shale volume in subsurface rock formations using the acoustic impedance and Vp/Vs ratio obtained by inversion from seismic data. The above-mentioned shortcomings associated with the prior art are addressed by way of the following novel improvements.

1) Coming up with a new rock physics model that relates the Vp/Vs ratio with acoustic impedance (AI), by-passing the use of elastic moduli (Bulk modulus, Shear modulus etc.) typically used to establish the relationship between these properties. Circumvent the use of Gassmann equation (Gassmann, 1951) for fluid substitution.
2) The Gassmann equation is useful; however, it requires the input variables at moduli level (Bulk modulus, Shear modulus etc.) instead of directly using the P- and S-wave velocities.
3) An essential part of this method is that the model can be calibrated using the nearest well penetrated in the zone of interest. The calibration yields the stress level/cementation factor, mineralogy factor, target shale's P-wave velocity (Vpₛₕ) and density (ρₛₕ).

These upper mentioned benefits are aimed at addressing the deficiencies in the prior art. The improved method is disclosed according to the appended independent claim. Advantageous further developments are subject of the dependent claims.

A first aspect of the present invention relates to a method for the estimation of shale volume in a reservoir comprising the following steps:
a) obtaining P-wave transit time (Δtₚ), S-wave transit time (Δtₛ), and bulk density (RHOB) data from the nearest well within the zone of interest. Converting the relevant data to acoustic impedance, Vp and Vs, finally plotting it onto the AI-Vp/Vs ratio function plane to obtain the stress/cementation factor, mineralogy factor, target shale's P-wave velocity (Vpₛₕ) and density (ρₛₕ) while calibrating the model in terms of zero and 100% shale volume contents.
b) obtaining inverted seismic data in the form of acoustic impedance (AI) and Vp/Vs ratio,
c) calculating the shale volume (Vsh) using the calibrated rock physics model inputting the AI and Vp/Vs cubes from inverted seismic.

### BRIEF DESCRIPTION OF THE DRAWINGS

Other features and advantages of the invention will be better understood from the following detailed description and the attached drawings in which:

FIG. 1 illustrates typical wireline log data acquisition for subsurface P- and S-sonic transit time, rock bulk density and other physical properties determination;

FIG. 2 is an illustration for seismic data acquisition in a marine set up in this case;

FIG. 3 shows a set of iso-volumetric content Vsh curved lines in a three-pole diagram onto AI-Vp/Vs plane;

FIG. 4 illustrates the plotting of the set of pairs on the same diagram of values of the parameters acquired in a well by three well-logging probes before the Vsh calibration;

FIG. 5 illustrates the plotting of the set of pairs on the same diagram of values of the parameters acquired in a well by three well-logging probes after the Vsh calibration;

FIG. 6 is an Acoustic impedance (AI) profile inverted from the seismic data. The profile is in time domain plotted against spatial distance. The darker the grey shade, higher is AI;

FIG. 7 is a Vp/Vs profile inverted from the seismic data. The profile is in time domain plotted against spatial distance. The darker the grey shade, higher is Vp/Vs;

FIG. 8 is the shale volume (Vsh) output obtained after using equation 3, represented by grey shades. The darker the grey shade, higher is the shale volume;

FIG. 9 shows the Vp/Vs plotted against the AI, both obtained from the inverted seismic. The shale volume (Vsh) calculated using the present method of the invention is represented by grey shades. The darker the grey shade, higher is the shale volume;

FIG. 10 is a flowchart showing elementary steps in one embodiment of the present inventive method.

### DETAILED EXAMPLE

The method of the invention comprises the use of AI and Vp/Vs inverted from seismic data, calibrated by well-logging tools making it possible to separate the influence of shale from water or hydrocarbon bearing sandstone, thus, to estimate the shale volume within sedimentary rocks. Subsurface shaly reservoirs may generally consist of three components: (1) the rock mineral matrix (e.g., quartz grains), (2) shale/clay, and (3) the fluid(s) within the pore space (water, oil/gas).

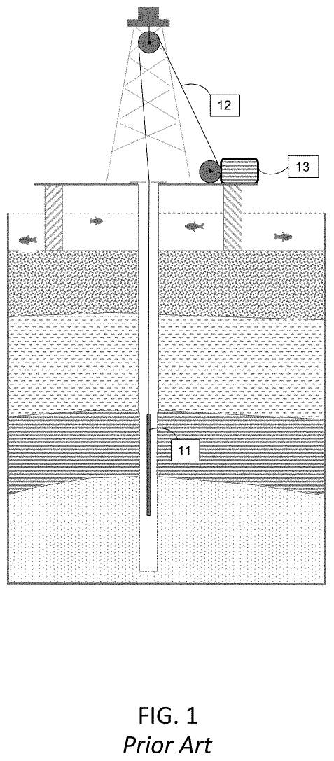

Data obtained from the wellbore may include so-called “well log” data. Such data are typically recorded and presented against depth in the subsurface of various physical parameters measured by probes lowered into the wellbore. Such probes may include, for example, electrical resistivity, compressional and shear wave sonic interval time, bulk density, neutron slowing down length, neutron capture cross-section, natural gamma radiation, and nuclear magnetic resonance relaxation time distribution, among others. The well logging procedure comprises recording of magnitudes of various above mentioned physical properties within a bore-hole using an array of logging probes (FIG. 1, 11), attached with a logging cable (12) connected on the other end to a data recording cabin (13).

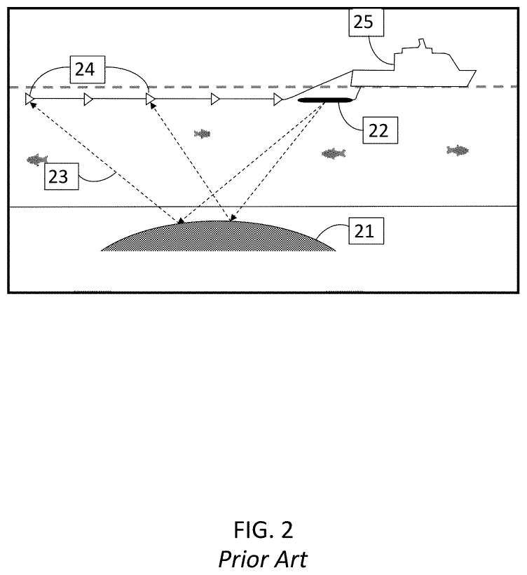

Seismic data acquisition is routinely performed both on land and at sea. At sea, seismic vessels deploy one or more cables (“streamers”) behind the vessel as the vessel moves forward. Each streamer includes multiple receivers in a configuration generally as shown in FIG. 2. Streamer comprising of receivers (24) trails behind a vessel (25), which moves forward as the survey progresses. As shown in FIG. 2, source (22) is also towed behind vessel (25). Source (22) and receivers (24) typically deploy below the surface of the ocean. Data is transmitted to the ship (25) through the cables that is recorded and processed. Source (22) emits seismic waves which reflect from boundaries (such as, e.g., formation boundary 21). The reflected waves are detected by receivers (24) and recorded as a function of time by determining the time it takes for seismic waves to propagate from source, reflected at a boundary (21) and back to receivers (24). The recorded signal may yield the information of the position, topography of boundary (21), rock, and in-situ fluid properties. The receivers used in marine seismology are commonly referred to as 215 hydrophones, or marine pressure phones. Inversion of seismic data, depending on the procedure, may yield acoustic impedance, shear impedance, P-wave velocity, S-wave velocity, P- to S-wave velocity ratio, and bulk density.

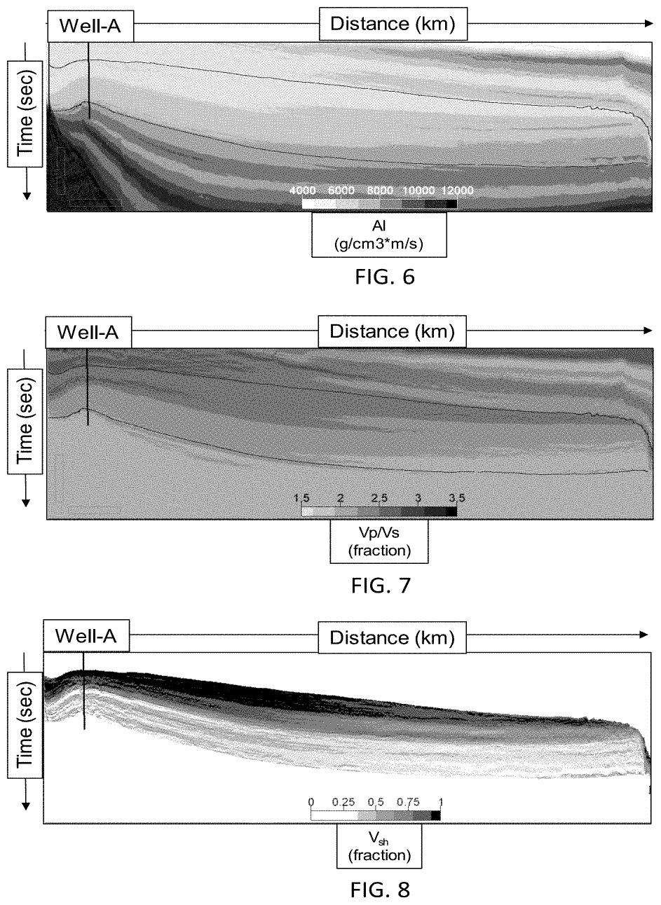

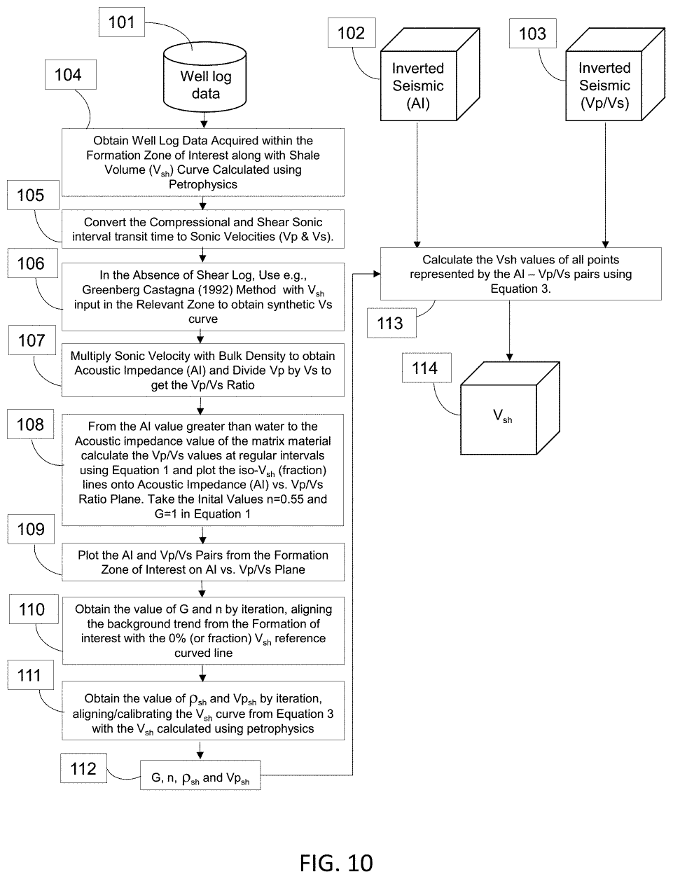

One embodiment of a method according to the invention, will be explained with reference to the flow chart in FIG. 10. The method of the invention makes use, in some embodiments, of data acquired from at least one wellbore (Well A in this case, FIGS. 6, 7&8) drilled through subsurface rock formations in an area of interest. The method of the invention contains first of all the calibration of model using three well-logging probes data appropriate for predicting the magnitude of volume of shale. The response of well-logging tools is dependent on the properties related to the components as well as their respective percentage in the rocks investigated. The tool measuring the compressional sonic transit time through the formations is sensitive to the rock porosity and the fluids it contains. The tool that measures the shear sonic is not sensitive to the fluids; however, it makes discrimination between various lithologies. The method involves converting both the compressional and shear sonic interval time to P- and S-wave velocities (Vp and Vs, respectively (105)). In the Absence of Shear Log, using e.g., Greenberg and Castagna (1992) method is possible with volume of shale input in the procedure to compute a synthetic Vs curve (106). The probe measuring the density is sensitive to water, other fluids and the void spaces/porosity between the matrix grains. The product of density with sonic derived velocity is called acoustic impedance. We used acoustic impedance values as a combined augmented response of the sonic and density probes', whereas the Vp/Vs ratio as the contrast in the P-wave and S-wave velocity response within the method of invention (107). The Vp/Vs ratio decreases with an increase in fluid saturation (hydrocarbon or CO₂ in the pore spaces) or organic matter, whereas the Vp/Vs increases with increase in porosity or volume of shale.

Acoustic impedance (102) and Vp/Vs ratio (103) are standard outcome of prestack inversion of seismic data. The seismic procedure yields independent measurements within a wide areal extent.

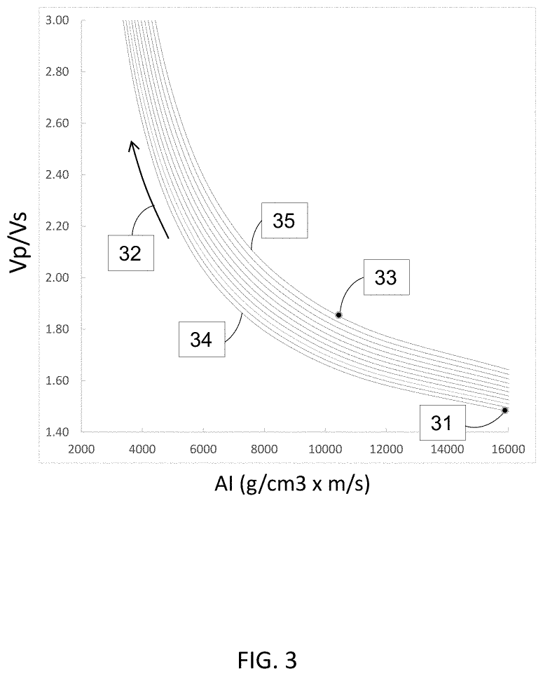

In a salt water-wet porous rocks, the two curves, i.e. acoustic impedance and Vp/Vs ratio respond to porosity. But in case of rock pores filled with hydrocarbon, or CO₂ both the acoustic impedance and Vp/Vs measurements respond due to two main effects: 1) the acoustic impedance responds to the presence of porosity and low-density, low-velocity fluids, and 2) the Vp/Vs ratio measurements respond to the rock matrix and pore fluids (gas/oil, CO₂). In a rock comprised of 100% matrix content with zero porosity (FIG. 3, 31), the Vp/Vs ratio will be equal to the velocity ratio of the matrix mineral. On the other hand, at water pole (32) the Vs becomes zero, resulting in an infinite Vp/Vs ratio.

The two properties obtained from the well log data are chosen also so that the collection of pairs of values of acquired parameters (namely the acoustic impedance on the one hand and the Vp/Vs ratio on the other) at least partly correspond to the equal shale volume (Vsh) for sedimentary rocks comprising a given proportion of matrix or water are substantially identical.

This selection of parameters substantially simplifies the operation for estimating the shale volume. In a cross-plot of the two chosen properties, the collection of pairs of values of the said parameters are spread over iso-volumetric content curves. A diagram may be drawn where the iso-volumetric content curved lines run parallel to a reference curved line (34) representing 0% (or 0 fraction) Vsh which joins a perceived water pole (32) with a 100% (or 1 fraction) mineral matrix pole (31).

If we assume the rock consists of a mineral matrix, shale/clay and water-filled matrix porosity then collection of pairs of values of the parameters serving as reference which is represented by the iso-volumetric content curved line equivalent to a given shale percentage within a rock obtained experimentally from values of the two chosen parameters acquired from the data.

This method of determining the G (mineralogy/shaliness coefficient) and n (stress/cementation coefficient) to align the 0% (or 0 fraction) Vsh zone data along the 0% (or 0 fraction) Vsh reference line implies that, among the zones crossed by the well, some are water-bearing, non-shaly, clean sandstone. This is possible if we assume the data pairs with low Vp/Vs ratio values occasionally showing a trend partly parallel to the 0% (or 0 fraction) Vsh reference line (34). It is possible to verify the existence of such zones by comparison with other shale volume calculation techniques within a basin. The pairs of values are represented by the set of iso-volumetric content curved lines, from the line with 0% shale volume to the line representing 100% shale volume (35), constrained by a shale pole (33), defined by the shale's P-wave velocity (Vpₛₕ) and density (ρₛₕ). The Vp/Vs which corresponds to that is then obtained by applying the following relation (Lee, 2003):

$$\frac{{V}_{P}}{{V}_{S}} = \frac{1}{[ G {α ( 1 - ∅ )}^{n} ]} \qquad ( 1 )$$

where Vp is P-wave velocity, Vs is S-wave velocity, G is mineralogy/shaliness coefficient, α is Vs/Vp ratio of the mineral/rock matrix, n is stress/cementation coefficient, and we derived the rock pore volume ϕ as:

$$∅ = \frac{\{ {ρ}_{m a} - {V}_{s h} [ ( {ρ}_{s h} - {ρ}_{m a} ) - A I ( \frac{1}{{V}_{P s h}} - \frac{1}{{V}_{P m a}} ) ] - \frac{A I}{{V}_{{P}_{m a}}} \}}{[ A I ( \frac{1}{{V}_{Pw}} - \frac{1}{{V}_{Pma}} ) - ( {ρ}_{w} - {ρ}_{m a} ) ]} \qquad ( 2 )$$

where V_{Pma}, V_{Psh} and V_{Pw} are the P-wave velocities of the mineral matrix, target shale and water respectively, ρₘₐ is density of mineral grains, ρₛₕ is density of target shale, ρ_{w} is density of water, AI is acoustic impedance and Vsh is the target shale volume (in fraction). Changing the mineralogy/shaliness coefficient ‘G’ results in a vertical static shift in the curved iso-volumetric content lines. The stress/cementation coefficient ‘n’ controls the slope of the iso-volumetric content curved lines and may be selected in a formation zone depending on level of stress, compaction, or cementation. The matrix, shale and fluid related constants may be taken from Mavko et al (2009) and vendors' logging chart books.

From this function (equation 1) we are able to define a set of lines representing different shale volumes parallel to the reference zero percent Vsh curve (that is usually a brine/water saturated sandstone) onto the Acoustic impedance-Vp/Vs ratio function plane (FIG. 3 & FIG. 10, step 108).

Rearranging the equation the shale volume can be calculated (in fraction) using the following equation:

$$\begin{matrix}{V}_{s h} = & ( 3 ) \\ \frac{\{ {ρ}_{m a} - \frac{A I}{{V}_{{P}_{m a}}} - [ 1 - {( \frac{{V}_{S}}{{V}_{P} G ∝} )}^{\frac{1}{n}} ] \\ [ A I ( \frac{1}{{V}_{Pw}} - \frac{1}{{V}_{Pma}} ) - ( {ρ}_{w} - {ρ}_{ma} ) ] \}}{[ ( {ρ}_{sh} - {ρ}_{ma} ) - A I ( \frac{1}{{V}_{Psh}} - \frac{1}{{V}_{Pma}} ) ]} & \end{matrix}$$

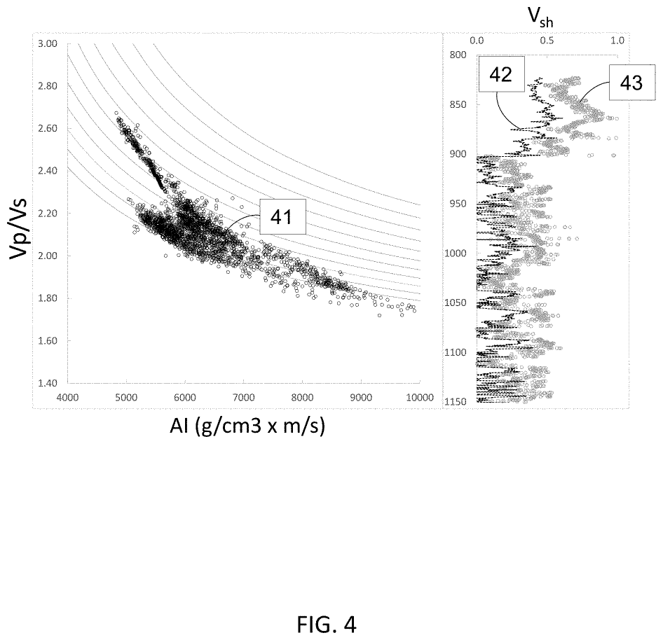

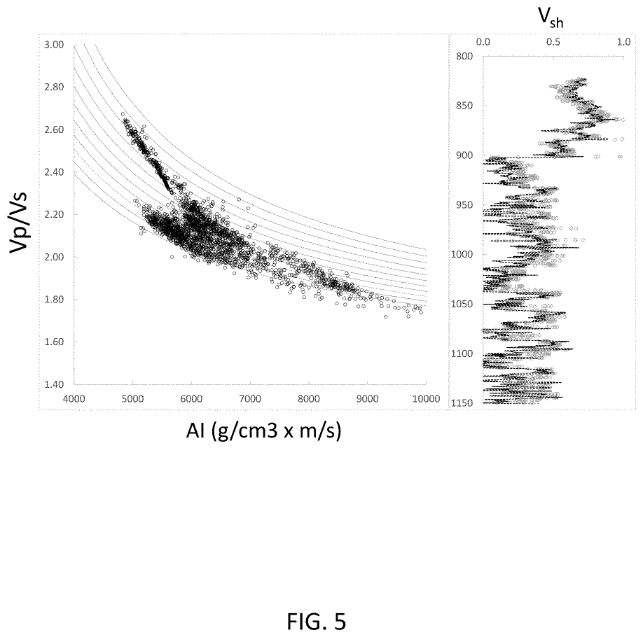

Until now the G, n, Vpₛₕ, and ρₛₕ are unknown. Plotting the well data (41) onto AI-Vp/Vs plane (FIG. 4) with some initial G and n values, and iterating the values of G and n making the perceived part of the data representing the water-saturated sandstone matrix to align with the 0% (or 0 fraction) shale volume line. The difference of Vsh calculated using equation 3 (42) with Vsh obtained from traditional petrophysical method (43) shows that the model is still not calibrated (FIG. 4). Iterating the Vp_{fl} and ρ_{fl} values so that the Vsh calculated using equation 3 calibrates with Vsh obtained from traditional petrophysical method (FIG. 5). The obtained G, n, Vpₛₕ and ρₛₕ values (FIG. 10, 112) are employed to insert in the step (113).

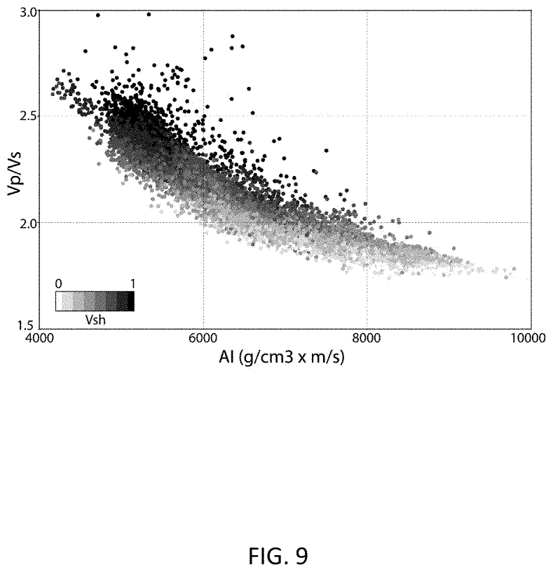

Putting both the AI (FIG. 6 & FIG. 10, step 102) and Vp/Vs (FIG. 7 & FIG. 10, step 103) data from inverted seismic with the G, n, Vpₛₕ, and ρₛₕₗ in equation 3 and calculate (113) to obtain the shale volume (Vsh) (114). The obtained Vsh profile in this embodiment is shown in FIG. 8, and the computed points from selected data plotted onto an AI versus Vp/Vs plane are illustrated in FIG. 9.

The technical solution is only one embodiment of the present invention, to those skilled in the art, the present invention discloses a fundamental principle of the method and applications, straightforward to make various types of modifications or variations, the method is not limited to the specific embodiments of the present invention described above, and therefore the manner described above are only preferred and is not in a limiting sense.

### References Cited

PATENT DOCUMENTS

| | | | |
|---|---|---|---|
| US | U.S. Pat. No. 5,583,825A | December 1996 | James Carrazzone, David Chang, Catherine |
| | | | Lewis, Pravin Shah, David Wang |
| WO | WO2015191971A1 | December 1996 | Fabio Marco Miotti, Jeremie Giraud |
| US | US2008015782A1 | January 2008 | Rebecca Saltzer, Christopher Finn, Shiyu |
| | | | Xu, Michael Farrel |
| US | U.S. Pat. No. 7,373,251B2 | May 2008 | Jeffry Hamman, Donald Caldwell, Fabien |
| | | | Allo, Raphael Bornard, Thierry Coleou, |
| | | | Thierry Crozat, Bernard Deschizeaux, Yves |
| | | | Lafet, Pierre Lanfranchi, Amelie Molle |

### OTHER PUBLICATIONS

### Aki, K., and P. G. Richards (1980), “Quantitative Seismology: Theory and Methods”, Freeman.

Bredesen, K., Rasmussen, R., Mathiesen, A., and L. H. Nielsen (2021): “Seismic amplitude analysis and rock physics modeling of a geothermal sandstone reservoir in the southern part of the Danish Basin”, Geothermics v. 89, 101974.
Connolly, P. (1999): “Elastic impedance”, The leading edge, v. 18, no. 4, p. 438-452.
Fatti, J. L., G. C. Smith, P. J. Vail, P. J. Strauss, and P. R. Levitt (1994): “Detection of gas in sandstone reservoirs using AVO analysis: A 3-D seismic case history using the Geostack technique”, Geophysics, v. 59, no. 9, p. 1362-1376.
Gassmann, F. (1951): “Über die elastizität poröser medien: Vierteljahrss-chrift der Naturforschenden Gesellschaft”, in Zurich 96, 1-23: Paper translation at http://sepwww.stanford.edu/sep/berryman/PS/gassmann.pdf.
Goodway, B., T. Chen, and J. Downton (1997): “Improved AVO fluid detection and lithology discrimination using Lamé petrophysical parameters; “λρ”, “μρ”, & “λ/μ fluid stack”, from P and S inversions”, in SEG Technical Program Expanded Abstracts 1997: Society of Exploration Geophysicists, p. 183-186.
Greenberg, M. L., and J. P. Castagna (1992): “Shear-wave velocity estimation in porous rocks: theoretical formulation, preliminary verification and applications1”, Geophysical prospecting v. 40, no. 2, p. 195-209.
Lee, M. W. (2003): “Velocity ratio and its application to predicting velocities”, US Department of the Interior, US Geological Survey.
Lehocki, I., P. Avseth, and N. H. Mondol (2019): “Seismic methods for fluid discrimination in areas with complex geological history—a case example from the Barents Sea”, Interpretation, v. 8, no. 1, p. 1-43.
Mavko, G., T. Mukerji, and J. Dvorkin (2009): “The rock physics handbook: Tools for seismic analysis of porous media”, Cambridge University Press.
Shuey, R. T. (1985): “A simplification of the Zoeppritz equations”, Geophysics, v. 50, no. 4, p. 609-614.
Smith, G. C., and P. M. Gidlow (1987): “Weighted stacking for rock property estimation and detection of gas”, Geophysical Prospecting, v. 35, no. 9, p. 993-1014.
Verm, R., and F. Hilterman (1995): “Lithology color-coded seismic sections: The calibration of AVO crossplotting to rock properties”, The Leading Edge, v. 14, no. 8, p. 847-853.
Whitcombe, D. N. (2002): “Elastic impedance normalization”, Geophysics, v. 67, no. 1, p. 60-62.
Yenwongfai, H. D., Mondol, N. H., Faleide, J. I., Lecomte, I., and J. Leutscher (2017): “Prestack inversion and multi-attribute analysis for porosity, shale volume, and sand probability in the Havert Formation of the Goliat Field, SW Barents Sea”, Interpretation, V. 5, p. 1-54. Zoeppritz, K. (1919): “Über Reflexion and Durchgang seismischer Wellen durch Unstetigkeitsflächen: Nachrichten von der Gesellschaft der Wissenschaften zu Göttingen, Mathematisch-Physikalische Klasse”, v. 1919, p. 66-84.

1. An analytical method to predict shale volume in a subsurface reservoir comprising the following steps:
using data provided by acoustic impedance (102) and P- to S-wave velocity ratio (103) inverted from seismic, and at least one nearest well providing preferably three well-logging probes measuring three different parameters (101), selected so that
a) the product of the P-wave velocity of sound obtained from one logging-tool with the density data obtained from the second logging-tool, hereby called acoustic impedance (107) develop in the same direction in response to a volumetric change of the water, and target fluid in the said sedimentary rocks,
b) the third probe measuring the S-wave velocity produces measurement signals hereby modified to a P- to S-wave velocity ratio (107) developing in opposite directions to each other due to the target fluid variation, on the one hand, and the water content, on the other, in the same sedimentary rocks, and
c) the three well-logging probes being further selected so that the resulting pairs within the acoustic impedance and P- to S-wave velocity ratio plane correspond to an equal shale volume, associated respectively with the said rocks comprising a given percentage of rock matrix or water, are equal represented by one pair of values of the representative parameters of the 100% shale volume, creating a system of sets of pairs of values of the acquired parameters, to obtain a continuous representation of the shale volume of the formations penetrated by the well,
characterised by
d) calibrating the zero percent shale volume trend within the formation of interest (110), simultaneously obtaining the cementation factor ‘n’ and mineralogy factor ‘G’ to further use in calculations, and
e) calibrating the shale volume computed from the acoustic impedance and P- to S-wave velocity ratio curves with shale volume ‘Vsh’ obtained from a conventional method by iterating P-wave velocity ‘Vpₛₕ’ and density ‘ρₛₕ’ of shale obtaining their values (111) to further use in calculations,
f) obtaining inverted seismic data in the forms of acoustic impedance (102) and P- to S-wave velocity ratio (103),
g) estimating a shale volume ‘Vsh’ (114) using the calibrated rock physics model by inputting the said data (113),
using equation
h)
$${V}_{s h} = \frac{\{ {ρ}_{m a} - \frac{A I}{{V}_{Pma}} - [ 1 - {( \frac{{V}_{S}}{{V}_{P} G ∝} )}^{\frac{1}{n}} ] \\ [ A I ( \frac{1}{{V}_{Pw}} - \frac{1}{{V}_{Pma}} ) - ( {ρ}_{w} - {ρ}_{ma} ) ] \}}{[ ( {ρ}_{sh} - {ρ}_{ma} ) - A I ( \frac{1}{{V}_{Psh}} - \frac{1}{{V}_{Pma}} ) ]}$$
where Vp is P-wave velocity, Vs is S-wave velocity, G is mineralogy/shaliness coefficient, α is Vs/Vp ratio of the mineral/rock matrix, n is stress/cementation coefficient, V_{Pma}, V_{Psh} and V_{Pw} are the P-wave velocities of the mineral matrix, target shale and water respectively, ρₘₐ is density of mineral grains, ρₛₕ is density of target shale, ρ_{w} is density of water, AI is acoustic impedance and Vsh is the target shale volume (in fraction).

2. The method of claim 1, wherein the measurements made by preferably three well probes are employed, adapted for measuring the density of the formation penetrated, the compressional and shear wave transit time of sound through the same ground.

3. The method of claim 2, wherein the measurements made by the P- and S-wave sonic tool are converted to P- and S-wave velocity (105), whereby product of the sound velocity values with the density readings obtained by the density tool is used, calling which as acoustic impedance values and the P-wave velocity divided by the S-wave velocity yielding the P- to S-wave velocity ratio (107).

4. The method of claim 2, wherein measurements made by a well probe measuring the S-wave transit time of the zone in the sub-surface and two other well probes measuring the P-wave transit time of sound and the density through this same zone, a representation diagram is chosen as a function of the P- to S-wave velocity ratio and of the acoustic impedance where said system of sets of pairs of values of the parameters acquired, each associated with the same volumetric content, may be likened to a set of parallel iso-shale volume curves (108), the shale volume associated with each pair of values of the acoustic impedance and of the P- to S-wave ratio measured in the well then being determined by identifying the shale volume curve passing through the point representative of said pair (109) in the chosen representation diagram.

5. The method of claim 2, wherein the slope of iso-volumetric content curves is controlled by the factor ‘n’ that is selected for a formation zone considering the cementation or stress level at the corresponding depth/temperature.

6. The method of claim 2, wherein the static shift of the iso-volumetric content curves is controlled by the factor ‘G’ that is controlled by the mineralogy of the matrix grains and clay content.

7. The method of claim 2. Wherein the distance of an iso-volumetric content line from the reference zero percent shale volume curve depends on the P-wave velocity and density of shale.

8. The method of claim 2, wherein the cementation ‘n’, and mineralogical factor ‘G’ are determined by iterating these factors, first aligning the zero percent shale volume from borehole data onto the acoustic impedance vs. P- to S-wave ratio plane with the zero percent shale volume reference curved line (110), whereas iterating the P-wave velocity and density of the target shale yielding their values, setting the 100% shale volume line, while calibrating with the shale volume logs calculated by traditional petrophysical methods (111).

9. The method as claimed in claim 2, in case the S-wave data was not acquired in a well, a synthetic S-wave data generated considering the shale volume can be used within the zone of interest (106).

10. The method of claim 1, wherein the reference set is established by selecting, from all the pairs of values acquired from the acoustic impedance and P- to S-wave velocity ratio inverted from seismic data, at least one specific pair of quantities for which a given shale volume in fraction or equivalent percentage may be associated.

11. The method of claim 1, wherein quantities from each pair of the parameters acquired in the acoustic impedance vs. P- to S-wave ratio is demonstrated in a diagram as a function of coordinates, one measuring acoustic impedance in the rock and the other the P- to S-wave ratio, where the collection of pairs of values equivalent to a corresponding content are manifested by a system of curved lines parallel to a reference curved line representing a zero shale volume in fraction or equivalent percentage, to which a given shale volume may be allocated, the position of the latter being ascertained by at least two representative points, one being associated with a rock which contains only the matrix and said given shale volume, the other with a pair of values acquired by the input data with which this same shale volume may be associated.

12. The method of claim 11, wherein the positions of the iso-shale volume curved lines are determined between an axis with the 100% rock matrix member on one end and the 100% shale volume on the other end, both represented by the values taken by the two parameters.

13. The method of claim 1, wherein the pairs of values typical of the water, shale and of the rock matrix are obtained from the existing literature.
